(19) United States
(12) Patent Application Publication
(10) Pub. No.: US 2011/0015962 A1
(43) Pub. Date: Jan. 20, 2011

(54) HIERACHAL PROVISIONING OF SERVICES

(75) Inventor: Rob Finucan, Manotick (CA)

Correspondence Address: PERLEY-ROBERTSON, HILL & MCDOUGALL LLP, 1400-340 Albert Street, OTTAWA, ON, K1R 0A5, CA

(73) Assignee: DUNGOLDEN GROUP INC., Ottawa (CA)

(21) Appl. No.: 12/502,370

(22) Filed: Jul. 14, 2009

(51) Int. Cl. G06Q 10/00; G06Q 50/00; G06F 11/07

(52) U.S. Cl. 705/9; 714/2

(57) ABSTRACT

Today failure or degradation in a single item of equipment for telecommunications or cable provider can impact one customer through to thousands of customers. Usually the first indication, particularly with customer premises equipment, is a call from the customer which if not resolved by the call centre staff triggers a series of visits from technicians over a period of days to weeks. It would be beneficial instead for the notification of the issue to go from the service provider to the original equipment manufacturer (OEM) for resolution using their additional resources before dispatching a repair technician. OEM engagement providing improved resolution as issues known to OEM and repairs resolution would not be known to the staff of the service provider. The OEM may then directly engage a professional services organization to perform the repair operation, with spares provided from the OEM warehouses identified in their initial analysis of the issue.

### CROSS-REFERENCE TO RELATED APPLICATIONS

This application claims the benefit of priority to Canadian Patent Application filed Jul. 10, 2009 entitled “Hierarchal Provisioning of Services” for which application serial number is currently unavailable.

### FIELD OF THE INVENTION

This invention relates to providing support services and more specifically to providing a hierarchy of support to address a fault within a provided service to a client.

### BACKGROUND OF THE INVENTION

In 2006 the U.S. market for consumer electronics was estimated to be approximately US$ 145 billion. Consumer electronics include electronic equipment intended for everyday use. Consumer electronics are most often used in entertainment, communications and office productivity. Some products classed as consumer electronics include personal computers (PCs), mobile telephones, telephones, MP3 players, personal digital assistants (PDAs), portable audio-visual equipment, televisions, calculators, Global Positioning Systems (GPS), automotive navigation systems, gaming consoles, digital cameras and camcorders, and playback/recording of video media such as DVDs, BluRay etc.

The vast majority of these consumer electronics devices, including PCs, telephones, PDAs, gaming consoles, audio-visual equipment, today are connected to a network, be it through a wireless network, a telecommunications company's wired network, a cable providers cable network, or satellite. As a result with the penetration of these devices essentially since 2000 the D.S. telecommunications market grew in 2006 to approximately $925 billion in revenue, while the worldwide telecommunications market grew approximately 11% to $3 trillion in revenue (Telecommunications Industry Association, 2007 Telecommunications Market Review and Forecast). Simultaneously capital expenditure within publicly owned wire line and mobile telecom service providers in North America during 2006 increased to approximately US$70 billion during 2006.

Consumer and business demand for broadband and high-speed services has typically fueled this growth, as telecommunications carriers invest in new fiber, new Internet Protocol (IP) technology, and new wireless infrastructure to provide state-of-the-art voice, video and data services. For example, more than 12 million miles of optical fiber were deployed in 2006 with nearly 10 million miles being deployed by the telephone companies as they maintain an ongoing speed/cost/reliability battle with cable television operators. Today the evolution of networks continues apace as whilst in 2006 cable modems and digital subscriber line (DSL) technology continued to dominate the U.S. market, capturing 96% of the broadband market, by 2010, 87% of Internet connections will be over broadband technology. Similarly although accounting for just 10% of U.S. wireless revenue in 2006, wireless data and multimedia services are forecast to make up 24% of all wireless revenue by 2010. Finally, Voice-over-IP (VoIP), the broadband-based phone technology, is forecast to make up 34% of all U.S. residential landlines by 2010, or 25.5 million subscribers, up from just 10% and 9.5 million subscribers in 2006.

Considering AT&T for example then in 2008 their annual revenue was $124 billion overall and they assigned 37% of this to the businesses, 18% to consumers and 40% to wireless. This was distributed over approximately 77 million wireless “lines”, 55 million fixed access lines and 12 million broadband access lines. In terms of types of service, wireless services contributed $44 billion, voice services $37 billion, and data services $24 billion (see AT&T 2008 Annual Report http://www.att.com/Common/about_us/annual_report/pdfs/2008ATT_FullReport.pdf)

Accordingly service providers, be they fixed wire line, wireless, or cable, must support and maintain a wide range of telecommunications equipment from the consumer side electronics or business electronics through to client side infrastructure, and out into the network infrastructure where hardware, firmware, or software failures increasingly affect more and more customers as the infrastructure at issue shifts from the local area network (LAN) to the metropolitan area network (MAN) and into the long-haul and ultra-long-haul backbone. To further exacerbate the issue the provider will typically have multiple vendors for each area of the network, and each vendor may be supplying multiple hardware platforms or devices into the same application. For example even something as simple as a telephone from Nortel Networks means it may be one of 5 Norstar™ terminals, or 5 telephones, approximately 12 VOIP phones, and 12 wireless telephones. Similarly an Ethernet Switch may be one of approximately 25 products from Nortel Networks alone.

Typically today the first indication of a failure somewhere within the network is a call from a disgruntled customer who is trying to find out why their service, Internet, telephone, television, etc is not working. Such calls are generally routed to the large call or contact centers operated by the service providers or outsourced by the service providers. With today's technology there is no reason why a U.S. call centre for a service provider actually be physically within the United States. Such first level client support typically consists of asking a few requisite questions to identify the client and verify their identity before asking the client to try a number of simple procedures according to the service and equipment they are calling about. Hence, residential clients may be asked to reset cable modems, personal wireless routers etc whilst business clients typically asked to report on status indicators on their client side equipment such as their private branch exchange (PBX) or reboot a server etc.

In most instances that is all the technical support the client receives before a service call is scheduled which will either cost the client automatically or if the visit turns out to have not been necessary. Typically such service calls are scheduled a few days in advance and are a window of typically 4 hours within the day. Such wide windows are frustrating and awkward for clients who must be at the premises with the fault within that timeframe until the technician appears, and in the intervening period either receives a degraded service or typically no service at all. Business clients where such downtime of services is critical will have entered a service level agreement (S LA) with the provider which may specify the levels of availability, serviceability, performance, operation, or other attributes of the service such as billing. For example banks within their SLA will have penalty clauses providing financial compensation for downtime which in areas such as centralized debit/credit financial clearing systems may be specified as dollars per second of outage.

When a service call has been scheduled and the fault cannot be rectified by the visiting technician then typically a subsequent service call is scheduled where a more qualified engineer visits specialized in the equipment at the client premises to perform more detailed fault correction and repair. However, even now in many instances the requisite repair parts may not be part of the standard equipment for the service engineer and hence a third visit will be required after the requisite spare has been obtained from the providers local parts storage facility.

In many instances the original equipment manufacturer (OEM) is unaware of the technical issues arising in the field with its equipment except potentially by correlating orders for spare parts from service providers to equipment sold to them comprising said spare part. However, in most instances the OEM is unaware of the issues as spare parts may be sourced by the service providers from secondary markets, which may be either used or so-called grey market wherein a third party manufacturer manufactures the part in question. In these instances the OEM would be unaware and the customer may unknowingly replace or have the broken component replaced with a spare component that may invalidate the customer's warranty with the OEM. Additionally the OEM may have identified the issue and developed a software resolution that could be provided to the client side equipment remotely via an Internet download. Such options would not be evident to the service or contact centre personnel handling the client calls and scheduling service calls. Further the OEM has in many instances engineering support either in house directly or available through value added resellers (VARs) and partnerships.

It would therefore be beneficial to provide a fault resolution for a customer that exploited the several layers of engineering and technical support within the chain from the service provider through to the OEM in a manner that allowed faults to be resolved in a more expedient manner for the client and potentially reduced the number of service calls, allowed for improved spares inventory and control, provided OEMs with enhanced network deployment information in respect of faults, client issues, service requests, etc and leveraged the information available from today's digitally based infrastructure. It would also be beneficial for the OEM or a professional services organization (PSO) supporting the maintenance and repair of the OEMs equipment to have a more intimate knowledge of software revision levels, hardware configurations so that they can improve capacity plans for production of equipment, or develop marketing plans to encourage customers to upgrade their existing equipment to newer technologies or revisions. For example if a majority of customers are at version 24 and the OEM has released version 30 as it's current production version of the firmware for its equipment then a marketing campaign may be developed by either the OEM or the PSO detailing the benefits and making special offers to upgrade. With the prior art systems the OEM is generally unaware of these aspects of their equipment as they are once removed from the final customer.

### SUMMARY OF THE INVENTION

It is an object of the present invention to obviate or mitigate at least one disadvantage of the prior art.

In accordance with an embodiment of the invention there is provided a method comprising the steps of receiving a notification relating to an item of equipment supporting a service from a service provider, the notification relating to at least one of a failure status of the item of equipment and a quality indicator relating to the service provided via the item of equipment and assigning the notification to an original equipment manufacturer, the original equipment manufacturer selected in dependence upon at least the item of equipment. The method further comprising the steps of assigning a corrective action to a professional service organization, at least one of generating the corrective action and selecting the professional service organization is made in dependence upon at least one of the notification, an aspect of the item of equipment, the service provider and original equipment manufacturer; and performing a repair operation to the item of equipment, the repair operation performed by at least one of an individual and a computer associated with the professional service organization.

In accordance with another embodiment of the invention there is provided a method comprising the steps of receiving a notification relating to an item of equipment supporting a service from a service provider, the notification relating to at least one of a failure status of the item of equipment and a quality indicator relating to the service provided via the item of equipment and providing a second notification relating to the item of equipment, the second notification sent from an original equipment manufacturer to the service provider, the original equipment manufacturer determined in dependence upon at least one of the item of equipment, the service provider employing the item of equipment, the service provided via the item of equipment, and a priority relating to the notification. The method further comprising the steps of assigning a corrective action to a professional service organization, at least one of generating the corrective action and selecting the professional service organization is made in dependence upon at least one of the notification, an aspect of the item of equipment, the service provider and original equipment manufacturer and performing a repair operation to the item of equipment, the repair operation performed by at least one of an individual and a computer associated with the professional service organization.

In accordance with another embodiment of the invention there is provided a method comprising the steps of receiving a notification relating to an item of equipment belonging a service from a service provider, the notification relating to at least one of a failure status of the item of equipment and a quality indicator relating to the service provided via the item of equipment and providing a second notification relating to the item of equipment, the second notification sent from a professional service organization to at least one of an original equipment manufacturer and the service provider, the original equipment manufacturer determined in dependence upon at least one of the item of equipment, the service provider employing the item of equipment, the service provided via the item of equipment, and a priority relating to the notification. The method further comprising the steps of assigning a corrective action to a predetermined part of the professional service organization, at least one of generating the corrective action and selecting the predetermined part of the professional service organization being made in dependence upon at least one of the notification, an aspect of the item of equipment, the service provider and original equipment manufacturer and performing a repair operation to the item of equipment, the repair operation performed by at least one of an individual and a computer associated with the predetermined part of the professional service organization.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic of an existing infrastructure relationship for a telecommunications provider with respect to client services and support;

FIG. 2 is a process flow for a telecommunications provider with respect to client services and support as depicted in FIG. 1;

FIG. 3 is a schematic of an existing infrastructure relationship for a cable provider with respect to client services and support;

FIG. 4 is a process flow for a cable provider with respect to client services and support as depicted in FIG. 3;

FIG. 5 is a schematic of an OEM assisted service and support approach according to an embodiment of the invention for a cable provider;

FIG. 6 is a schematic of an OEM assisted service and support approach for a service provider according to an embodiment of the invention

FIG. 7 is a process flow for an OEM assisted service and support approach for a service provider according to an embodiment of the invention such as depicted in FIG. 6;

FIG. 8 is a process flow for an OEM assisted service and support approach for a service provider according to an embodiment of the invention;

FIG. 9 is a schematic of an OEM assisted service and support approach for a service provider according to an embodiment of the invention;

FIG. 10 is a schematic of a multiple OEM assisted service and support approach for a service provider according to an embodiment of the invention;

FIG. 11 depicts the geographical disposition of resources within Canada for supporting a Canadian service provider according to an embodiment of the invention; and

FIG. 12 depicts an embodiment of the invention wherein the service provider directly engages a professional services organization for some faults prior to escalation of the fault correction to the OEM.

### DETAILED DESCRIPTION

The present invention is directed to providing a support services and more specifically to providing a hierarchy of support to address a fault within a provided service to a client

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

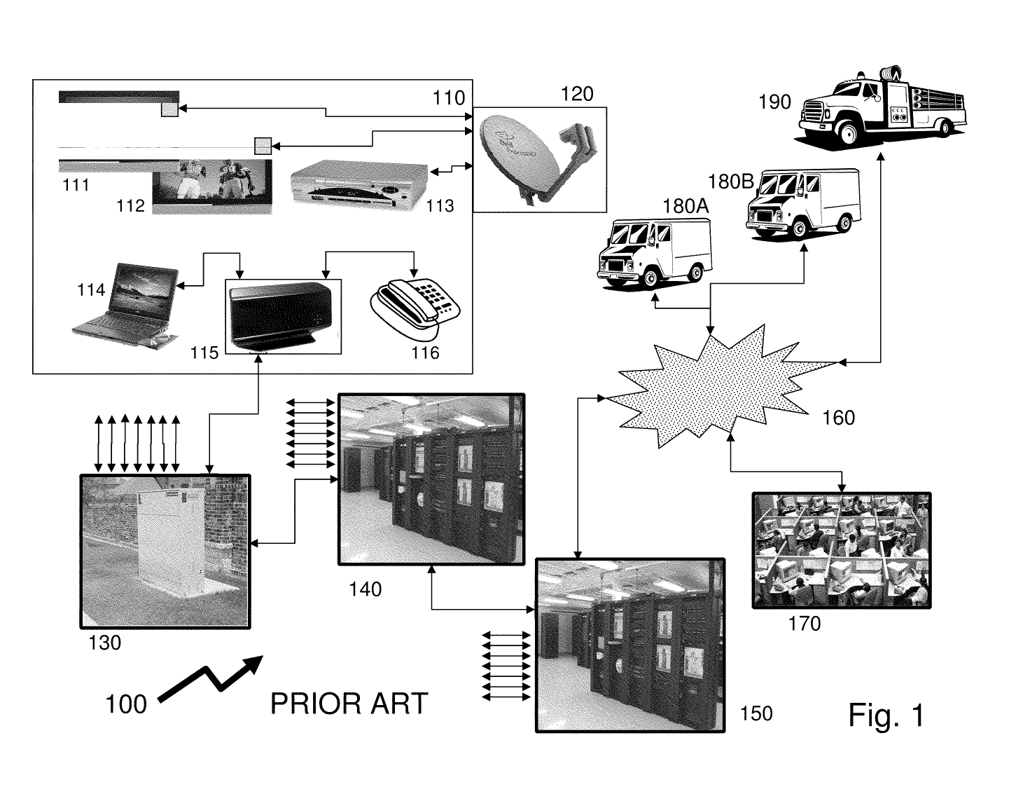

As illustrated in FIG. 1 there is a configuration schematic 100 of an existing infrastructure relationship for a telecommunications provider with respect to client services and support. The configuration schematic 100 depicts subscriber premises 110 wherein the subscriber (not shown) receives a variety of services through either a modem 115 or satellite dish 120 from a provider. For example the provider may be Bell Canada who provides Internet and telephony services over the modem 115 but due to infrastructure constraints provides television and associated video services through the satellite dish 120 which is provided from their Bell ExpressVu™ service. As noted supra telephone operators accounted for approximately 80% of the optical fiber deployments in 2006 as they sought to address the increasing dominance of cable in providing bundled services such as the so-called triple play of telephony, Internet and television over their single cable headend. Examples of other providers in such situations include AT&T whom today offer wireless, telephony and Internet but have no telephony offering at present whilst they upgrade their network with optical fiber and the subsequent rollout of “Advanced TV”.

As such the subscriber premises have two televisions 111 and 112 connected to the satellite dish 120 as well as a high-definition personal video recorder (HD-PVR). The subscriber additionally having a laptop 114 and telephone 116 connected to the modem 115, which for example is a high speed digital subscriber loop modem (HS-DSL). For Bell Canada such a modem 115 being for example a Ethernet SpeedStream 5200 ADSL Modem from Efficient Networks or an ITEX DSL Model from Dell Computers and with AT&T a Motorola Model 2210 DSL Modem. The satellite dish 120 being in receipt of signals from a satellite which are transmitted to the satellite from a ground station (not shown for clarity). The modem 115 is connected to a pedestal 130 within the local area of the subscriber premises 110. The pedestal supports a large number of local premises and may be either a wiring hub or multiplexer hub according to the implemented infrastructure of the provider within that neighborhood. A wiring hub for example may receive a cable containing 1024 wiring strands and distribute these such that 256 are distributed locally and the remaining 768 loop to another pedestal 130. In contrast a multiplexed hub may receive a single strand at OC-12 (622 Mb/s), demultiplex an OC-3 (155 Mb/s) stream therefrom which is then demultiplexed to 96 DS-1 channels (1.55 Mb/s). The non-dropped portion of the OC-12 signal being routed to another pedestal 130.

The pedestal 130 is fed from a local office 140 which supports a digital exchange and handles for example all telecom services to a small town, a residential neighborhood or part of a city. Each local office according to the particular digital exchange typically supports between 10,000 and 100,000 subscribers feeding multiple pedestals 130 and from these subscriber premises 110 which may be residential, commercial or businesses. Businesses may themselves host a private branch exchange (PBX). The local office 140 is then interconnected another local office 150 and therein to a telecommunications network 160 across North America, and from submarine cables or satellite to the global telecommunications network.

Interconnected to the telecommunications network 160 is a call centre 170 which provides customer support and sales for the provider, e.g. Bell or AT&T, to its subscribers. Also connected to the telecommunications network 160 are installation/repair technicians 180A and 180B together with network engineers 190, wherein these technicians and engineers receive work instructions from the call centre 170 or other offices within the provider's enterprise.

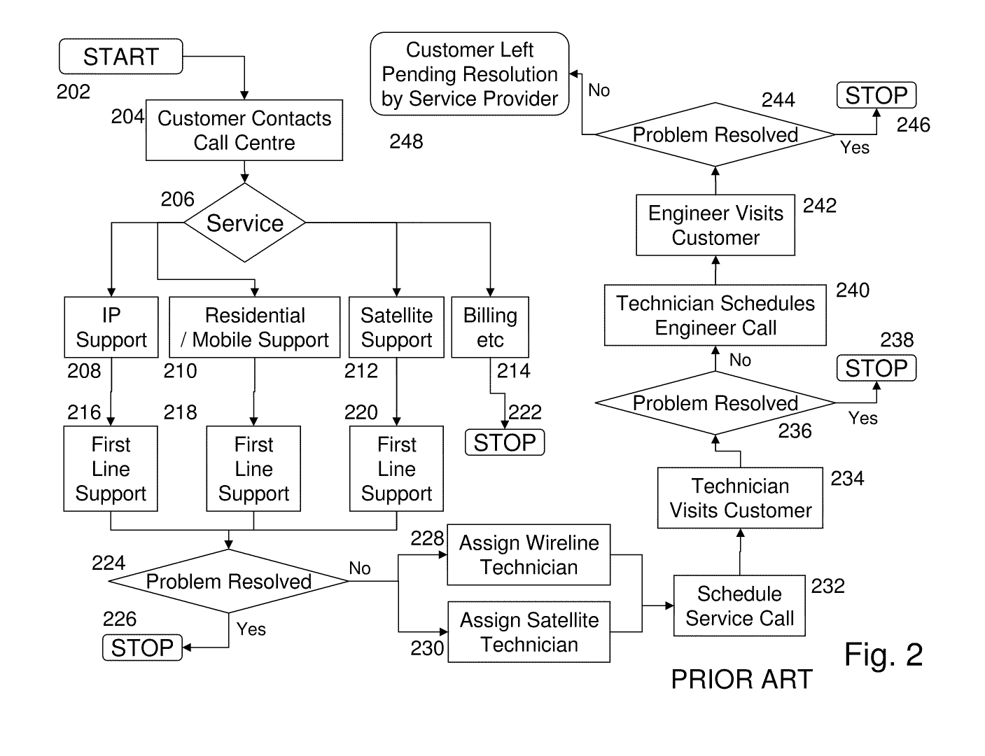

Now referring to FIG. 2 there is shown a process flow for a subscriber engagement with a telecommunications provider with respect to client services and support as depicted in FIG. 1 for the current prior art. The process begins at step 202 with a fault occurrence, which may be degradation in service or a complete failure in a service. Hence at step 204 the customer contacts the call centre, such as call centre 170 in FIG. 1, using for example their residential line via telephone 116 of FIG. 1. At step 206 the customer is prompted for the service to which their call relates, and if the call relates to alternate options of billing, account enquiries, moving, ordering additional services or features etc then the process moves to step and thereupon stops for sake of clarity. Upon determining that the customer is calling about Internet problems then the process moves to step 208 and the call is routed to operators in first line support addressing such issues at step 216 such as with Bell Canada. If the customer is calling regarding residential/mobile telephone issues then the flow moves to step 210 and the call is routed to the first line support for telephony in step 218 such as with Bell Mobility or Bell Canada. For satellite support the process moves to step 212 and the call routed to operators in step 220 addressing the Bell ExpressVu service rather than Bell Canada or Bell Mobility.

Typically each of the first line support operators 216 through 220 have predetermined scripts to follow which aim to identify the problem and address the common simple issues that arise with customers such as those related to using the equipment, services stopping for non-payment, etc. At step 224 the first line support operators 216 through 220 will determine whether the problem has been resolved, and if it has the process moves to step 226 and stops. If not then a technician visit will be scheduled which according to the service of the customer and their equipment will be assigned to either a wire line technician in step 228 or a satellite technician in 230. Then in step 232 the service call is scheduled based upon the existing schedule of the technician selected and the client. Subsequently, typically a few days later and within a stated window of typically 3 or 4 hours, i.e. between 9 am and 1 pm on Friday June 26^{th} when customer calls at 10:15 am on Tuesday June 23^{rd}, the technician visits in step 234 and attempts to resolve the issue.

At step 236 if the problem is resolved the technician will update the work sheets for themselves and according the providers service/customer databases with respect to the work order and outstanding issue, and the process moves to step 238 and stops. If the problem is not resolved then the technician typically will have isolated the root cause but is not qualified or authorized to perform the repair and hence an engineer visit would be scheduled by the technician at step 240. Typically the provider will have a limited engineering staff and a reasonably large direct or contract technician base. As such the next visit for the customer with the engineer may be scheduled for July 3^{rd} within a window of 2 pm to 6 pm, just over a week away. If the problem is external to the customer premises 110 then the engineer visit would be scheduled without consideration of the customer schedule and hence may be slightly early perhaps as July 1^{st}. Therefore in step 242 the engineer visits to correct the fault, which is then determined in step 244 as to whether they have or not, and if so the process moves to step 246 and stops. For external fault issues the engineer will typically be able to determine whether they have resolved the problem as they will carry portable test equipment which will characterize the line or lines they are working upon and notify them whether the line(s) are within acceptable performance limits.

If the engineer is unable to solve the problem then the process moves to step 248, the customer is left without a restored service or a partially restored service and awaits correction of the problem. Typically the service provider will not be able to provide the customer with an update when they call again to the call centre 170 as the call centre 170 databases do not access the maintenance/repair schedules for the provider's network infrastructure. This can leave the customer frustrated and ultimately leading to their switching service provider, an option which in the current digital telecommunications environment is a relatively simple process for them of just a phone call to their selected new provider or logging in to the new provider's website and completing a request for new service.

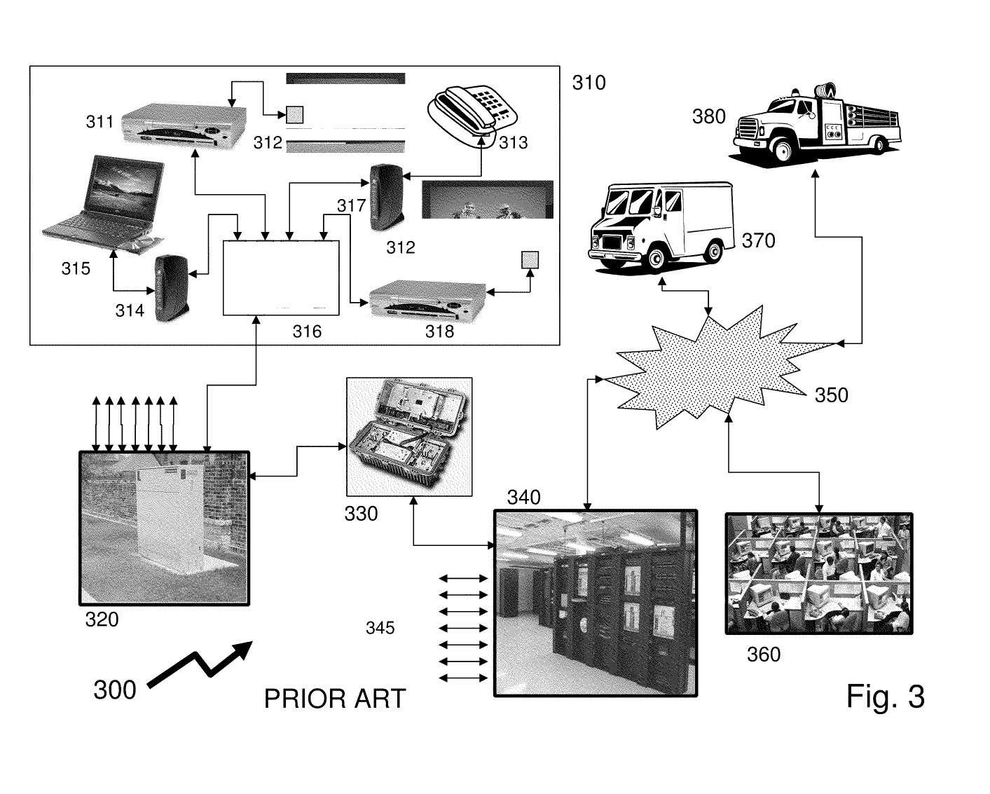

As illustrated in FIG. 3 there is a configuration schematic 300 of an existing infrastructure relationship for a cable provider with respect to client services and support. The configuration schematic 300 depicts subscriber premises 310 wherein the subscriber (not shown) receives a variety of services. The subscriber premises are fed with a cable which is terminated with a cable splitter 316, for example as shown a 1:4 splitter. From one output of the cable splitter 316 the cable signal is routed to a first modem 314, such as Motorola SB5102 SURFboard™ Cable Modem, which then is connected to a laptop computer 315. A second output from the cable splitter 316 is routed to a second modem 317 which is connected to a telephone 313, the second modem 317 being for example a Motorola SBV5121 SURFboard™ Digital Voice Modem allowing the subscriber to exploit VOIP for their telephone service with the cable provider. A third output of the cable splitter 316 is fed to a first cable set top box 311 and therefrom to a television 312, the first cable set top box for example being a high definition modem such as the Cisco Explorer 4250HD. A fourth output of the cable splitter 316 is fed to a second cable set top box 318 and therefrom to a television 312, the first cable set top box for example being a HD-PVR such as the Cisco Explorer 8300DVR.

The cable splitter 316 is connected to a pedestal 320 within the local area of the subscriber premises 310. The pedestal supports a large number of local premises and may be either a passive hub or an active hub according to the implemented infrastructure of the provider within that neighborhood. A passive hub for example may simply contain additional splitters to split the received signal to for example 64, 96, 128 subscribers from a tapped portion of the incoming signal wherein the untapped portion is routed to another pedestal 320. In contrast an active hub may receive the cable signal, tap a predetermined portion of the received signal, boost the untapped portion before routing it to another pedestal 320, and boost/split the tapped portion to for example 128, 256 subscribers or more/less according to network architecture.

The pedestal 320 is fed from a head end 340 via a trunk amplifier 330 which is typically provided on a pole. The head end 340 would typically support all services to a small town, a residential neighborhood or part of a city. Each head end 340 according to the particular architecture of the provider typically supports between 10,000 and 100,000 subscribers feeding multiple pedestals 330 via multiple trunk amplifiers 330, and from these subscriber premises 310 which may be residential, commercial or businesses. Businesses may themselves host a private branch exchange (PBX). The local office 340 is then interconnected to a telecommunications network 350 across North America, and from submarine cables or satellite to the global telecommunications network.

Interconnected to the telecommunications network 350 is a call centre 360 which provides customer support and sales for the provider, e.g. Bell or AT&T, to its subscribers. Also connected to the telecommunications network 360 are installation/repair technicians 370 together with network engineers 380, wherein these technicians and engineers receive work instructions from the call centre 360 or other offices within the provider's enterprise.

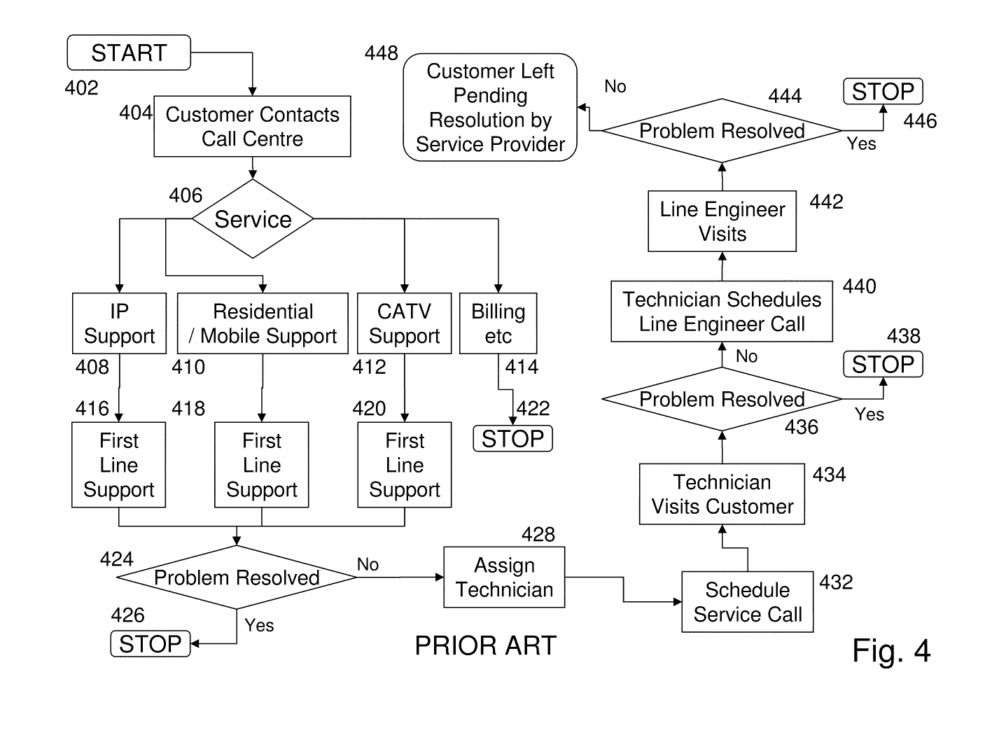

Now referring to FIG. 4 there is shown a process flow for a subscriber engagement with a cable provider with respect to client services and support as depicted in FIG. 3 for the current prior art. The process begins at step 402 with a fault occurrence, which may be degradation in service or a complete failure in a service. Hence at step 404 the customer contacts the call centre, such as call centre 360 in FIG. 3, using for example their residential line via telephone 313 of FIG. 3. At step 406 the customer is prompted for the service to which their call relates, and if the call relates to alternate options of billing, account enquiries, moving, ordering additional services or features etc then the process moves to step and thereupon stops for sake of clarity. Upon determining that the customer is calling about Internet problems then the process moves to step 408 and the call is routed to operators in first line support addressing such issues at step 416. If the customer is calling regarding residential/mobile telephone issues then the flow moves to step 410 and the call is routed to the first line support for telephony in step 418. For CATV support the process moves to step 412 and the call routed to operators in step 420.

Typically each of the first line support operators 416 through 420 have predetermined scripts to follow which aim to identify the problem and address the common simple issues that arise with customers such as those related to using the equipment, services stopping for non-payment, etc. With cable providers such as Rogers providing services in areas such as Ottawa, Ontario in Canada or Videotron providing services to areas such as Montreal, Quebec in Canada, the first line support operators are able to send limited test signals allowing them to verify that the subscriber premises 310 is “visible” to the network and how many modems and/or cable set top boxes are “visible”.

At step 424 the first line support operators 416 through 420 will determine whether the problem has been resolved, and if it has the process moves to step 426 and stops. If not then a technician will be assigned in step 428 based upon the location of the subscriber premises. Then in step 432 the service call is scheduled based upon the existing schedule of the technician selected and the client. Subsequently, typically a few days later and within a stated window of typically 3 or 4 hours, i.e. between 9 am and 1 pm on Friday June 26^{th} when customer calls at 10:15 am on Tuesday June 23^{rd}, the technician visits in step 434 and attempts to resolve the issue.

At step 436 if the problem is resolved the technician will update the work sheets for themselves and according the providers service/customer databases with respect to the work order and outstanding issue, and the process moves to step 438 and stops. If the problem is not resolved then the technician typically will have isolated the root cause but is not qualified or authorized to perform the repair and hence an engineer visit would be scheduled by the technician at step 440. Typically the provider will have a limited engineering staff and a reasonably large direct or contract technician base. As such the next visit for the customer with the engineer may be scheduled for July 3^{rd} within a window of 2 pm to 6 pm, just over a week away. If the problem is external to the customer premises 310 then the engineer visit would be scheduled without consideration of the customer schedule and hence may be Saturday June 27^{th}. Therefore in step 442 the engineer visits to correct the fault, which is then determined in step 444 as to whether they have or not, and if so the process moves to step 446 and stops. For external fault issues the engineer will typically be able to determine whether they have resolved the problem as they will carry portable test equipment which will characterize the line or lines they are working upon and notify them whether the line(s) are within acceptable performance limits.

If the engineer is unable to solve the problem then the process moves to step 448, the customer is left without a restored service or a partially restored service and awaits correction of the problem. Typically the service provider will not be able to provide the customer with an update when they call again to the call centre 360 as the call centre 360 databases do not access the maintenance/repair schedules for the provider's network infrastructure. This can leave the customer frustrated and ultimately leading to their switching service provider, an option which in the current digital telecommunications environment is a relatively simple process for them of just a phone call to their selected new provider or logging in to the new provider's website and completing a request for new service.

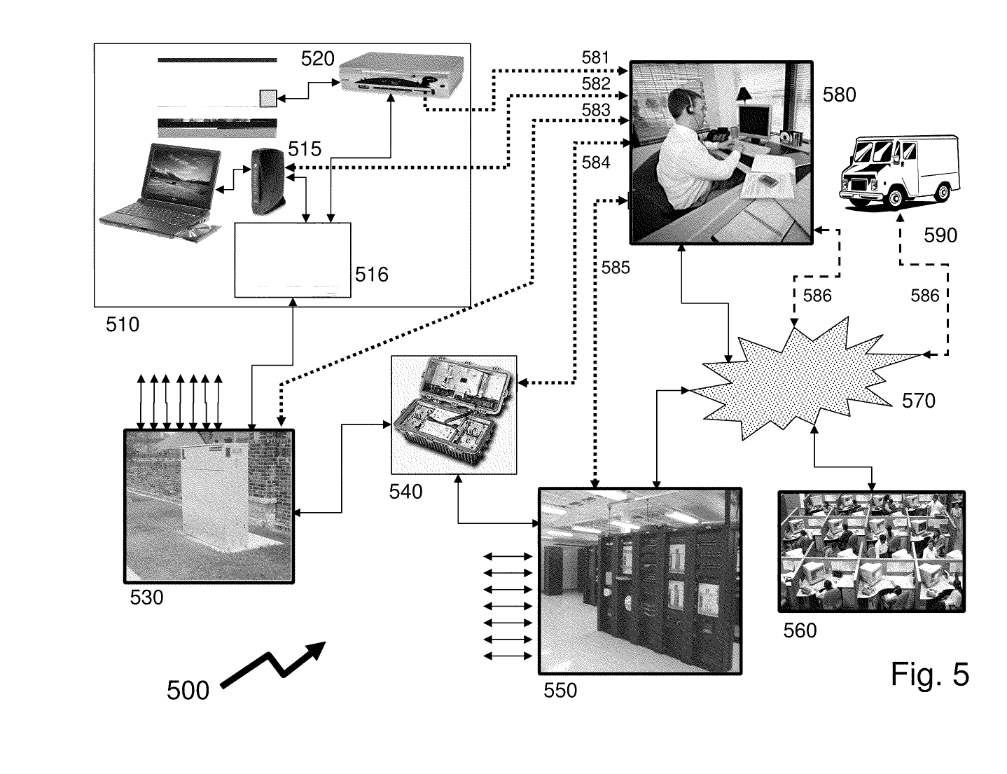

Now referring to FIG. 5 there is shown a schematic 500 of an OEM assisted service and support approach according to an embodiment of the invention for a cable provider. In this schematic 500 a subscriber premises 510 is shown comprising a cable modem 515, such as Cisco EPC3000 DOCSIS 3.0 4×4 Cable Modem, and cable set top box 520, such as Cisco Explorer 8300PVR. The cable modem 515 and cable set top box 520 being connected to the cable network via cable splitter 516 which is fed from pedestal 530. The signals provided to customer are fed to the pedestal from the cable head end 550 and intermediate trunk amplifier 540. As supra the cable head end 550 is connected to a telecommunications network 570 which may be a dedicated network of the provider or one sharing resources with other providers or be hosted by a separate entity. Also connected to the telecommunications network 570 is the provider customer call centre 560 and technician 590. However, unlike the preceding telecommunications provider and cable provider scenarios from the prior art as depicted within FIGS. 1 and 3 respectively there is also connected an OEM 580. Due to the equipment provided by the OEM 580 to the cable provider then the OEM is able to remotely access equipment such as cable set top box 520 via first virtual link 581, cable modem 515 via second virtual link 582, pedestal 530 via third virtual link 583, trunk amplifier 540 via fourth virtual link 584, and cable head end 550 through fifth virtual link 585. Additionally the OEM 580 is able to provide information to the technician 590 via a sixth virtual link 586.

The links from the OEM 580 to equipment are referred to as virtual links for differentiation from the links existing within the equipment between the various elements of the cable provider network. The OEM 580 may access the equipment using communications protocols on service bands within the cable provider network or may access the equipment through a separate network entirely or a combination of the two. Accordingly the OEM 580 may interrogate the remote equipment using their own or other commercially available configuration/analysis tools and provide remote configuration/upgrade of the equipment.

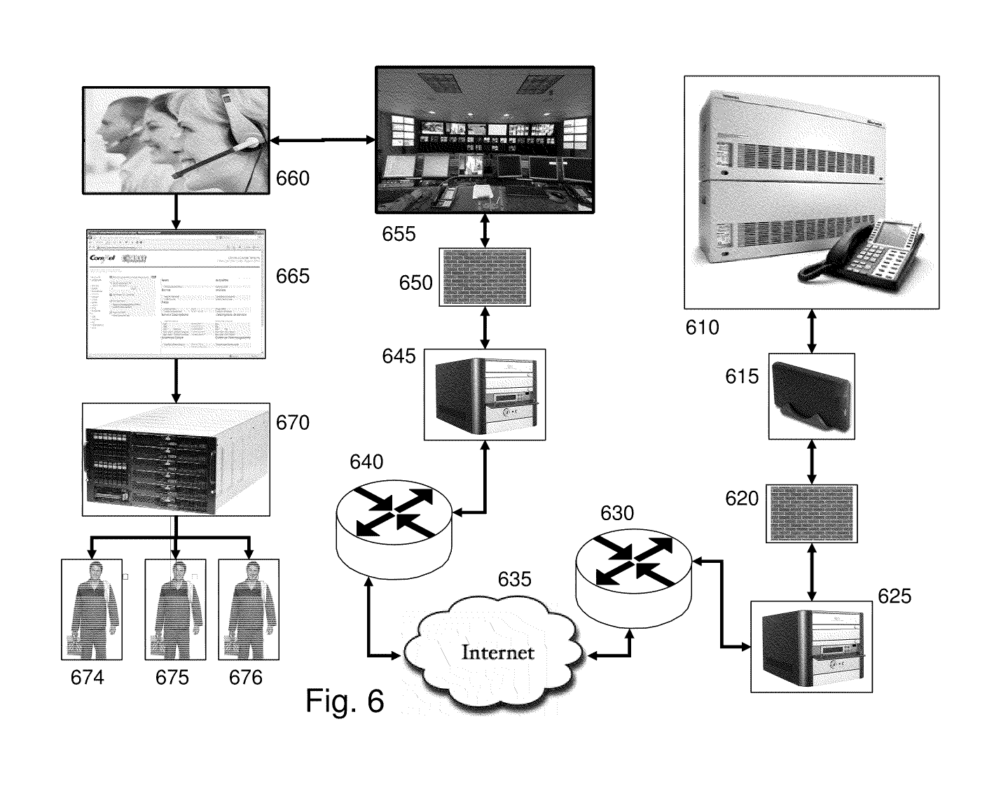

Now referring to FIG. 6 there is shown a schematic of an OEM assisted service and support approach for a service provider according to an embodiment of the invention. As shown there is a customer side PBX 610 which operates and connects to a telecommunications network which is not shown explicitly for clarity. Interfaced to the PBX 610 is a site event buffer 615 which stores data relating to fault events within the PBX 610. Either based upon a predetermined threshold of severity, an accumulation of events to a predetermined number or a trigger from the OEM 655 the event buffer 615 downloads its stored contents to the OEM 655. The download being achieved by establishing a secure access channel through the PBX firewall 620, first virtual private network (VPN) 625, first router 630, the Internet 635, second router 635, second VPN, OEM firewall 650 and therein to the servers of the OEM 655. The OEM 655 upon determining fault corrections to the errors retrieved from the event buffer 615 can access the PBX 610 through the same, or another secure tunnel, to correct the issues or can schedule a fault service call either upon failure to remotely repair or where remote repair is not possible. In this event the OEM 655 connects with a professional services organization (PSO) 660 which has accredited repair/calibration/service/installation engineers. The PSO 660 upon receiving the request from the OEM 655 creates a web ticket 665 relating to the fault which identifies essential information such as customer, location, equipment, fault, work undertaken to date, additional information from event buffer 615 as appropriate, etc. This web ticket 665 is then stored within the PSO server 670 and notification of the pending web ticket sent to an appropriate technician. Shown for example only are first technician 674 located in Calgary, Alberta, Canada who is too remote to the PBX 610 which is located in Cornwall, Ontario, Canada. Also shown is second technician 675 based in Ottawa, Ontario, Canada about 120 km from the PBX 610 but who lacks accredited service training for the Nortel Meridian 1 Option 61C PBX which comprises PBX 610. Also shown is third technician 676 based in Montreal, Quebec, Canada about 150 km from the PBX 610 but who does have the required Nortel training to service the Meridian 1 Option 61C PBX installed with 500 lines for a Government organization. Accordingly the management systems within the PSO in generating the web ticket 665 had correlated location, equipment and training to associated third technician 676 with the web ticket 665 and schedule his visit accordingly.

It would be apparent to one skilled in the art that the scheduling of the visit of the third technician may be adjusted according to the particular fault such as it's severity as well as service level agreements in place between the organization owning the PBX 610, in this scenario the Government, and the OEM 655 as well as the agreement between the OEM 655 and PSO 660.

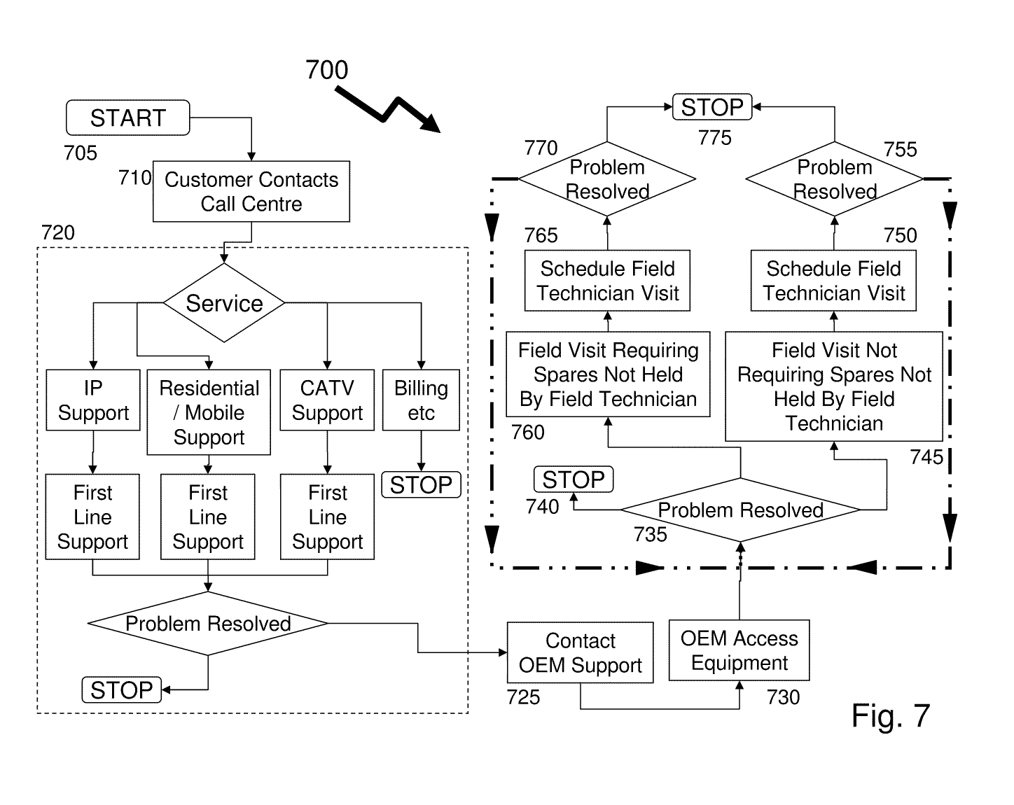

Now referring to FIG. 7 there is shown a process flow 700 for an OEM assisted service and support approach for a service provider according to an embodiment of the invention such as depicted in FIG. 6. Accordingly the process flow 700 begins with a fault occurring at a customer in step 705 whereupon the customer contacts the call/support centre for their provider in step 710. Next in step 720 the provider attempts to resolve the problem with their normal customer engagement and analysis work flow such as presented supra in respect of telecommunication provider in steps 206 through 226 of FIG. 2 and for a cable provider in steps 406 through 426 in FIG. 4.

Lack of resolution for the problem results in the call centre of the provider contacting the OEM support centre in step 725. The OEM support centre selected based upon the service, equipment, fault etc identified during step 720. For example in respect of cable provider if the problem was identified as either first cable modem 311, Motorola SB5102 SURFboard™, or second cable modem, Motorola SBV5121 then the OEM contacted may be Motorola, and if the equipment was the first cable set top box 311, Cisco Explorer 4250HD, then the OEM contacted may be Cisco. However, in other scenarios the cable provider may have a blanket agreement in place with Cisco who supports the Motorola products as part of the agreement as they are legacy equipment for example, or the Motorola products offer a better cost fit to the cable provider agreement than the Cisco cable modems, etc.

Having received the request from the provider in step 725 the OEM then access the identified faulty equipment in step 730 and attempts to resolve the problem using a link to the equipment. For example, the Motorola modem may be operating with an old firmware version that is known to have a certain lock-up based upon events and the OEM then downloads a newer version of the modem firmware thereby resolving the problem. If the problem is resolved with the link from the OEM then at step 735 the problem is flagged as resolved, databases within the OEM and provider updated to remove the open work order in respect of a customer problem and the process moves to step 740 and stops.

If the problem is not resolved and the OEM determines in step 745 that the problem can be resolved using a customer visit without requiring spares which are not part of the normal spare inventory carried by field technicians then the process moves to step 750 and the OEM schedules a field technician visit with the customer directly. In step 755 after the field technician visit it is determined whether the problem has been resolved. If it has the process moves to step 760 and stops. If the problem has not been solved then the process loops back to step 735 wherein it is reanalyzed. In the case that the first field technician could not solve the problem as it turned out a spare was required after all that they did not have, or the initial assessment is that a field technician visit will require a spare that is not normally part of the inventory for a field technician then the process moves to step 760 and determines what spares are required, where does inventory exist and then uses this information alongside that of the customer and field technician to schedule the visit in step 765. Next in step 770 it is determined whether the fault has been corrected, if so the process moves to step 760 and stops. If not the process returns to step 735 and the problem escalates within the OEM work schedules and additional actions taken.

It would be apparent that the field visits may be made by technicians/engineers of one or more PSOs associated with the OEM rather than the field technicians/engineers of the OEM themselves and still provide the overall functionality discussed supra in respect of FIGS. 6 and 7. It would be further apparent that the PSO may be determined based upon other factors such as for example the equipment, geography, availability, experience of technicians, etc.

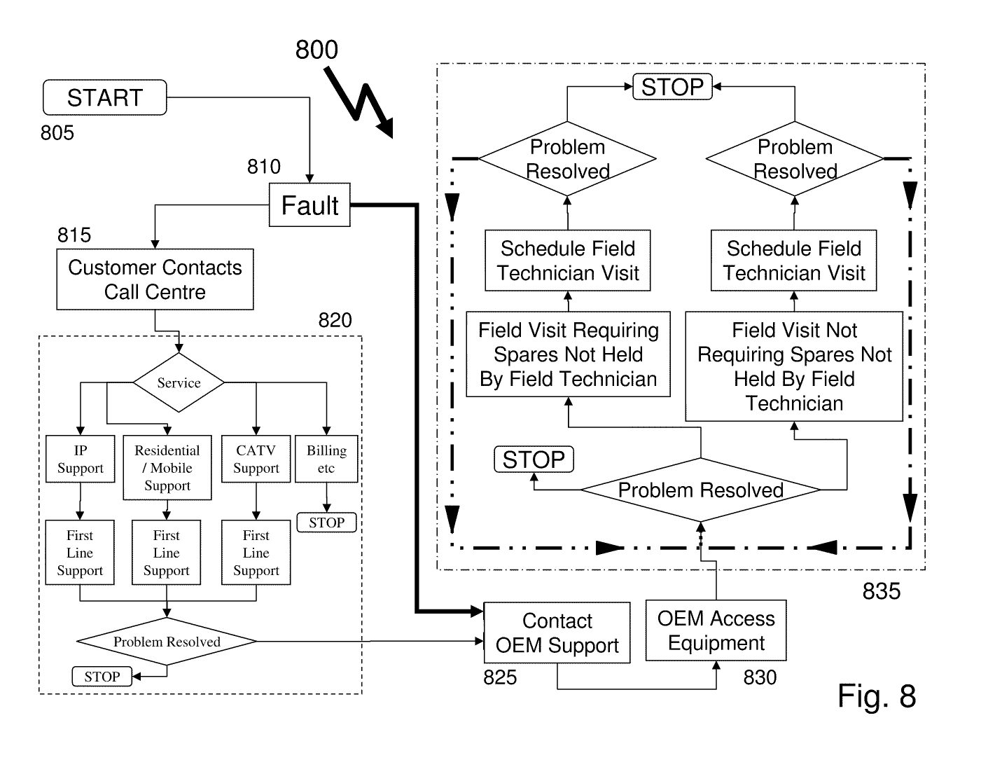

Referring to FIG. 8 is a process flow 800 for an OEM assisted service and support approach for a service provider according to an embodiment of the invention. Again the process begins at step 805 and proceeds to a fault at step 810. If we consider for example the PBX 610 discussed supra in respect of FIG. 6 then if the fault is a low level event whilst it is stored within the event buffer 615 it may not be communicated to the OEM. The process would then move to step 815 wherein the customer contacts the call centre, although there will be many faults within the PBX 610 that are not noticed by the customer and are not reported although they are captured within the event buffer 615. Once the customer contacts the provider then the process moves to sequence block 820 and the routine customer engagement occurs, such as discussed supra in FIGS. 2, 4, and 7. If the fault is corrected then the process stops but if not then the provider contacts the OEM support group in step 825.

Alternatively at step 810 if the fault was a high level fault then the event when stored within the event buffer may have automatically triggered the establishment of the secure tunnel from the PBX 610 to the OEM such that the OEM is contacted again at step 825. From step 825 the process flow 800 moves forward to step 830 wherein the OEM accesses the equipment and attempts to resolve the issue and the process moves forward to sequence steps 835. Sequence steps 835 being similar to steps 735 through 775 presented supra in respect of FIG. 7.

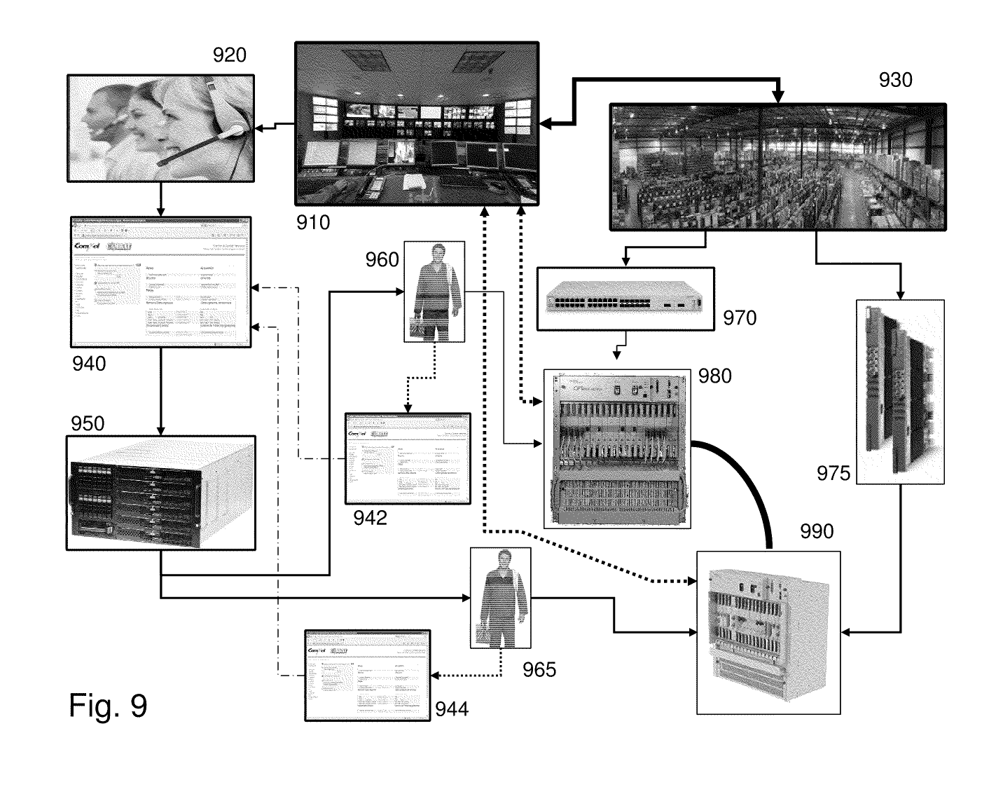

It would be apparent that the automatic triggering of service engagements with the OEM for high level events or faults within the customer equipment may extend to the provider equipment. For example referring to FIG. 9 there is shown a schematic of an OEM assisted service and support approach for a service provider according to an embodiment of the invention wherein coordination of personnel and equipment is required. The OEM support centre 910 has previously received a support request from an OEM in respect of a fault within the deployed provider equipment, such as at step 725 of FIG. 7 for example. The OEM has now resolved that the correction of the fault will require spares not normally carried by the field technicians, such as at step 760 of FIG. 7 supra. Further the OEM has an agreement with a PSO 920 in respect of the field technician resources.

Accordingly the OEM support centre 910 has determined that the issue relates to two pieces of equipment, the first a Nortel Networks OPtera Metro 5200 platform 980 deployed in the MacDonald campus of McGill University in Pointe Claire, Quebec, Canada and a Nortel Networks OPtera Long Haul 1600 platform 990 deployed in downtown Montreal, Quebec, Canada. In the Nortel Networks OPtera Metro 5200 platform 980 a replacement 10 G/100 G Ethernet Switch 970 is required, whilst the Nortel Networks OPtera Long Haul 1600 platform 990 requires two replacement OC-48 DWDM transmitter blades 975.

The OEM support centre 910 contacts its warehouse 930 to determine availability and location of the 10 G/100 G Ethernet Switch 970 and OC-48 DWDM transmitter blades 975. This information is then retrieved and provided to the PSO 920 as part of the contact to open the web ticket 940 for the repair of the Nortel Networks OPtera Metro 5200 platform 980 and Nortel Networks OPtera Long Haul 1600 platform 990. This web ticket being stored within the PSO server 950 and communicated to first and second technicians 960 and 965 respectively as first and second partial web tickets 942 and 944 respectively. The first and second technician 960 and 965 have their schedules/availability/training etc stored within the PSO server 950 databases allowing the PSO 920 to schedule the activity with the OEM 910 based upon the technician availability and the spares availability from the warehouse 930. Once the schedule has been confirmed the reserved spares are retrieved and dispatched by the warehouse, the dispatch being for example to the first and second technicians 960 and 965 respectively, or to the goods inward facilities at the two locations in downtown Montreal and Pointe Claire with the faulty equipment, or to a warehouse of the PSO 920 for example.

The first technician 960 therefore is able to repair the Nortel Networks OPtera Metro 5200 platform 980 using the replacement 10 G/100 G Ethernet Switch 970 and therefore updates a first partial web ticket 942 which is fed back to the master web ticket 940 held by the PSO. Similarly the second technician 965 is able to repair the Nortel Networks OPtera Long Haul 1600 platform 990 requires two replacement OC-48 DWDM transmitter blades 975, whereupon the second partial web ticket 944 is updated and fed back to the master web ticket 940. Completion of the first and second partial web tickets 942 and 944 respectively therefore completes the web ticket 940 which is then communicated to the OEM support centre 910 by the PSO 920.

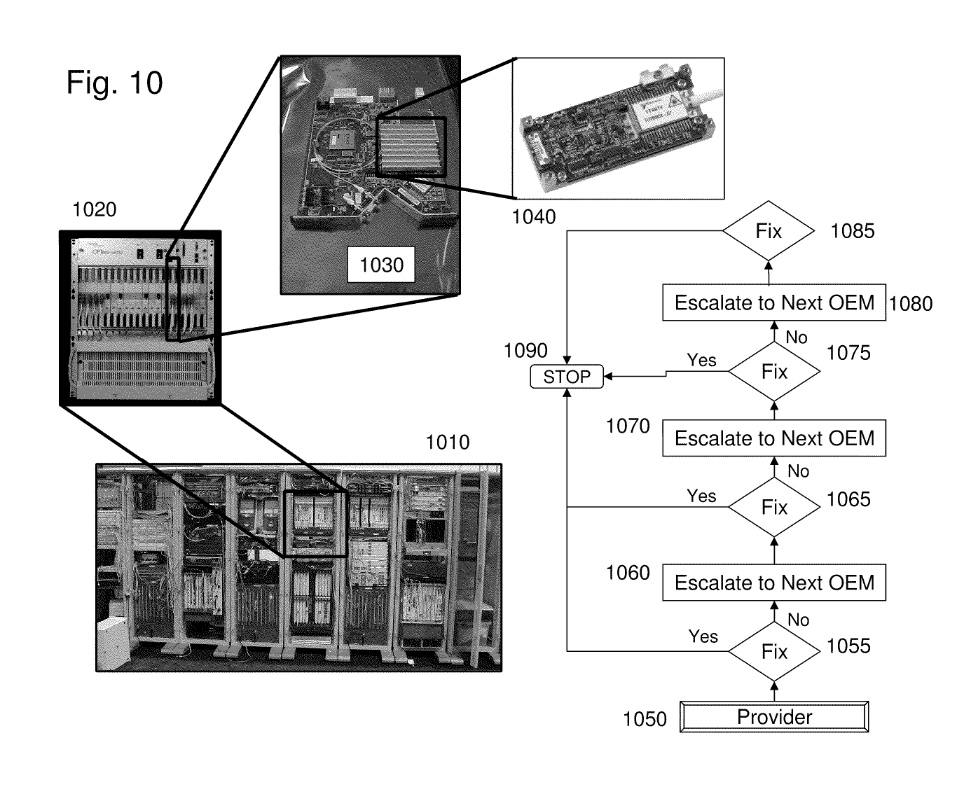

Now referring to FIG. 10 there is shown a fictional schematic of a multiple OEM assisted service and support approach for a service provider according to an embodiment of the invention. As shown a service provider, for example VoX Communications (www.voxcorp,.net) in Colorado, U.S.A, has a central office 1010 which comprises equipment from potentially multiple vendors, one item of which is an OPtera Metro rack 1020. Now considering the process flow of FIG. 10 also then the provider 1050 identifies that a fault has occurred within the OPtera Metro rack 1020 which was procured from Network System Resellers (www.trustncr.com) based in Littleton, Col., U.S.A and escalates the fault correction to them in step 1060 having failed to correct it themselves at step 1055. VoX Communications then in step 1065 in failing to correct the problem moves the process forward to step 1070 and escalates the fault correction further to Nortel Networks who provided an OC-48 Tunable DWDM Transmitter blade 1030 to retrofit into the OPtera Metro rack 1020.

Nortel Networks now in attempting to correct the fault identifies that it cannot in step 1075 and escalates the issue to the next OEM at step 1080, being Bookham Technologies (now Oclaro www.oclaro.com) who provided the LambdaFLEX™ iTLA TL5000 Integrated Tunable Laser Assembly 1040 to the OC-48 Tunable DWDM Transmitter blade 1030. As such Bookham now fixes the problem in step 1085 and the process moves to step 1090 and stops. Any previous step in the process resulting in a correction to the fault would have similarly led to the process moving forward to step 1090 and stopping.

Alternatively the process flow may have terminated at an intermediate point if the intermediate OEM did not have a service agreement in place with their supplying OEM, i.e. Network System Resellers with Nortel Networks, or Nortel Networks with Bookham Technologies. It would also be evident that the hierarchy presented may in many instances have more levels, less levels and that whilst the particular hierarchy shown related to a hardware fault with an optical component the process flow may have flown differently for a microcomputer issue within the OPtera Metro rack 1020 which then led to a microprocessor issue and the embedded firmware therefrom relating to for example a RISC core employed within the microprocessor.

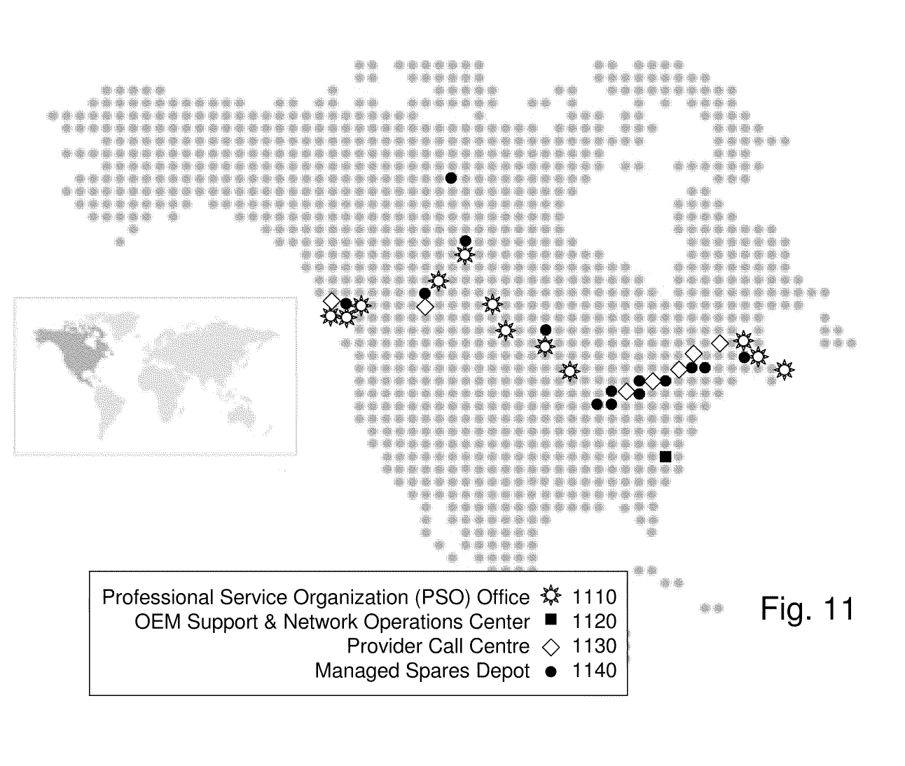

Referring to FIG. 11 there is shown an exemplary network of office relating to an OEM, such as the one operating the OEM support centre 910 in FIG. 9 supra, and a PSO, such as PSO 920 of FIG. 9 supra, wherein the PSO supports the Canadian operations of the OEM. Accordingly the service provider operates 7 Provider Call Centres 1130 across Canada, these being located in Ottawa, Quebec City, Montreal, Toronto, London, Calgary, and Vancouver. A customer call to the free support telephone number for the service provider routes the call based upon location of the customer relative to the Provider Call Centres 1130 and their current loading. Such Provider Call Centres 1130 corresponding to the contact/support centres of the service provider discussed supra.

The OEM supplying network infrastructure and customer premises equipment provides a single OEM Support & Network Operations Centre 1120 in Raleigh, N.C., U.S.A. This provides coverage for all of their North American operations as they support service providers in both the United States and Canada. Accordingly the contact from the service provider to the OEM support center would be made from one of the Provider Call Centres 1130 to the OEM Support & Network Operations Centre 1120 where the first line support operators are unable to address and resolve the problem, such as at steps 725 or 825 in FIGS. 7 and 8 respectively. The Professional Services Organization (PSO) operates offices 1110 in 11 locations across Canada, namely Halifax, Moncton, Fredericton, Winnipeg, Saskatoon, Regina, Edmonton, Red Deer, Victoria, Vancouver, and Nanaimo. Which PSO Office 1110, corresponding to PSO 920 for example in FIG. 9 supra, is contacted by the OEM Support & Network Operations Centre 1120 would be determined based upon a combination of factors, including for example proximity to the customer or network infrastructure requiring the maintenance/repair visit, the training/certification of the technicians at the different offices, their current loading, etc.

It would be apparent that the OEM may operate one or many redundant, geogrpahically dispersed support and network operations centres for disaster recovery purposes or 7×24 coverage. For example if Raleigh, N.C. OEM Support & Network Operations Centre 1120 failed or closed for the day, then all information would flow to another OEM Support & Network Operations Centre, not shown for clarity, such as in Munich, Germany or Bangalore, India for example thereby reliability and coverage purposes.

Further as discussed supra the OEM would maintain inventory at Managed Spares Depots 1140, corresponding to the warehouse 930 for example in FIG. 9. Where the OEM has significant infrastructure deployed with the service provider and does so for the service provider's entire Canadian network the OEM might manage a large number of Managed Spares Depots 1140, such as at Calgary, Edmonton, Burnaby, Winnipeg, Yellowknife, Hamilton, Breslau, London, Ottawa, Pickering, Windsor, St Laurent, St Foy, and Dartmouth.

Whilst the facilities engaged in supporting the service provider have been presented in FIG. 11, and in other embodiments described in FIGS. 5 through 10, with respect to one OEM and one PSO it would be apparent that there may be several OEMs and multiple PSOs according to the service provider procurement activities, i.e. are they limited to say 2 or 3 equipment OEMs to source all their infrastructure and customer premise equipment. Further each OEM may engage one PSO for a country, a province/state or geographic area as they determine appropriate for their support of the service provider. Alternatively the PSO may themselves operate Managed Spares Depots or warehouses. Further whilst the embodiments have been presented supra with an outsourced PSO for the OEM the technicians may at times include those within the service provider itself according to the agreements, resources, skills etc.

It would be evident to one skilled in the art that the processes described supra in respect of embodiment of the invention have primarily been described with respect to customer side equipment and the triggering of events by the customer in response to a fault. However, it would be apparent that the processes described may equally apply to the equipment operated by the provider external to customer premises. In these scenarios aspects of the described embodiments such as for example customer contacts, first line support etc would be omitted.

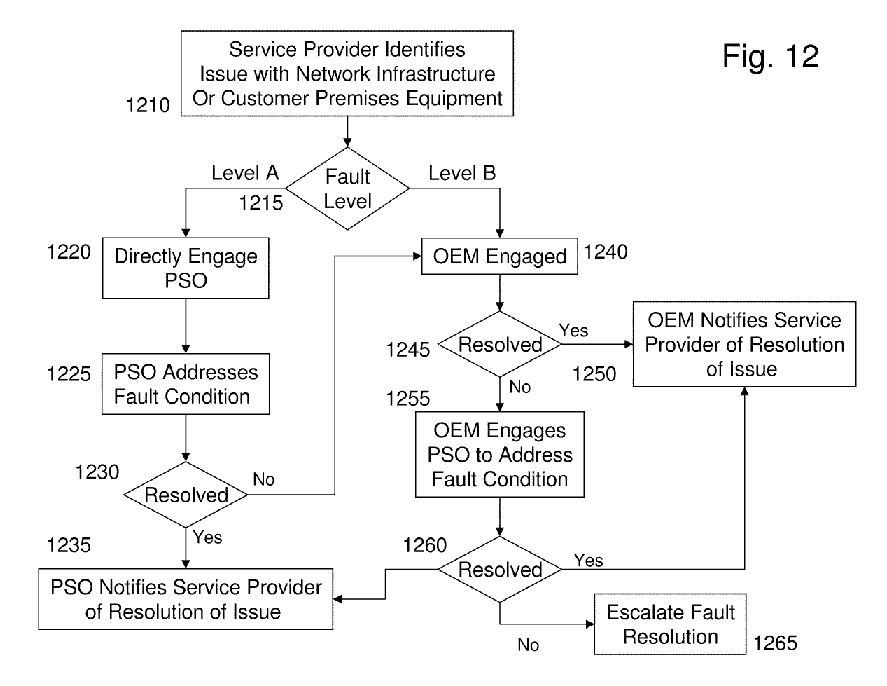

Further whilst the scenarios presented supra in respect of FIGS. 5 through 11 have been presented with respect to the OEM having the means to remotely access and address issues with either network infrastructure or customer premises equipment it would be evident to one of skill in the art that these remote access rights, skills, etc may be present within and be provided by the PSO themselves. In many instances the OEM may automatically identify the fault and contact the PSO such that the PSO performs the corrective actions and fault diagnosis rather than the OEM. In other instances it might be that the service provider directly engages a PSO such that particular faults or issues are addressed by the PSO without the direct engagement of the OEM who is advised in background and aware of the issues but does not become directly engaged unless the PSO cannot resolve the problem. Such a process flow is shown in FIG. 12. The process starts at step 1210 where the service provider identifies and issue with either their network infrastructure of the customer premises equipment and at step 1215 assigns a fault level to the identified fault. For a “Level A” fault the service provider directly engages the PSO in step 1220 who attempts to rectify the fault in step 1225. At step 1230 it is determined whether the fault has been corrected. If so the process moves to step 1235 with the PSO notifying the service provider of the resolved issued. If it is not resolved then the process moves to step 1240 wherein the OEM in engaged. After attempting to resolve the issue it is determined in step 1245 whether the problem has been resolved. If so then the OEM notifies on behalf of the PSO that the fault condition has been corrected at step 1250.

If the problem has not been resolved and requires the PSO to visit the faulty equipment and provide the corrective action then in step 1255 the OEM engages the PSO to perform the required field service call. At step 1260 it is determined whether the problem is resolved, if it is then the service provider is either notified by the OEM in step 1250 or by the PSO in step 1235. Lack of resolution to the fault condition causes the process to move forward to step 1265 with an escalation of the fault correction activity.

If the fault condition was determined by the service provider at step 1215 was established at “Level B” then the process would have moved to directly engage the OEM at step 1240. Alternatively escalation from the PSO to the OEM upon the initial fault activities failing may be made via the service provider. Optionally the service provider and OEM may employ different PSO groups without departing from the scope of the invention.

It would also be apparent that the service support provided between service provider—OEM—PSO may operate upon several levels. For example, the service level agreements may specify three levels of alarm, critical, major and minor. A “Critical Alarm” also known within telecommunications as a “Severity 1 Problem”, indicates a severe service affecting faults in the telecommunications network that requires immediate action. Examples of Critical Alarm conditions include:
Major alarm light lit;
Call processing capability is lost, i.e., a dead system;
System restarts;
System degradation for reasons such as 50% or more of trunk lines are out of service;
50% of stations out of service;
Call Center is impacted or unable to process calls; and
Other critical alarms, as defined by Service Provider and agreed upon by OEM.

Accordingly the PSO would provide support continuously (24×7) until the Severity 1 Problem is resolved or a satisfactory interim solution is provided to service provider. In performing such support the PSO would typically have “Fault Acknowledgement Objectives” agreed such as:
acknowledging the Severity 1 Problems within 15 minutes of it's being flagged by the OEM to the PSO, where such an acknowledgement may mean opening a web ticket for the fault and remotely accessing the identified equipment to verify fault status, alarms and retrieve stored fault condition information; and
identifying a corrective action plan and implementing the plan within 60 minutes of the Severity 1 Problem being flagged.

Next for a “Major Alarm”, also known as a Major Problem, indicates a major service affecting fault in the network or customer premises equipment that require action but is not a Severity 1 problem. Such problems being where system or software functionality is limited to some degree however the loss of functionality has only minimal impact on the customer operations, or a work-around solution exists which minimizes the operational impact of the problem. Typical examples of Major Alarm conditions include:
Alarm light lit;
10% of trunks out of service;
10% of stations out of service; and
Other critical alarms, as defined by Service Provider and agreed upon by OEM.

Accordingly the PSO would provide support continuously (24×7) until the Major Problem is resolved or a satisfactory interim solution is provided to service provider. In performing such support the PSO would typically have “Fault Acknowledgement Objectives” agreed such as acknowledging the Major Problem within 30 minutes of it's being flagged by the OEM to the PSO, where such an acknowledgement may mean opening a web ticket for the fault and remotely accessing the identified equipment to verify fault status, alarms and retrieve stored fault condition information.

For faults not identified as Critical or Major then they would be assigned to the third category, “Minor Alarm” which service affecting fault in the network or customer premises equipment that does not jeopardize service and does not require immediate correction. Examples of such Minor Alarm conditions include:
Minor alarm light lit;
Any condition less severe than a Major Problem;
Software configuration error; and
Audible alarms inoperative.

Accordingly the PSO would provide support to correct fault in a timely manner, and the PSO Fault Acknowledgement Objectives may be that acknowledging the Minor Problem within 60 minutes of it's being flagged by the OEM to the PSO, where such an acknowledgement may mean opening a web ticket for the fault and remotely accessing the identified equipment to verify fault status, alarms and retrieve stored fault condition information.

In the exemplary embodiments of the invention presented supra in respect of FIGS. 5 through 12 a trigger was typically provided by a customer contacting a call centre of the service provider to report an issue. However, it would be apparent that other reporting mechanisms may be employed without departing from the scope of the invention. Such mechanisms for example include routine polling of equipment by the OEM, for example to an event buffer such as event buffer 615 of FIG. 6. The OEM then provides reports to either the PSO or the customer directly on a regular basis as to the alarms that have been generated, problems fixed or problems that were not fixed according to the service level agreement between the OEM and PSO or OEM and customer. In many instances the OEM may be able to proactively fix problems before they become known to the customer or PSO, this being possible as today's technology typically means small problems do not often cause noticeable degradation in service but many small problems can cause a major failure.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
(a) receiving a notification relating to an item of equipment supporting a service from a service provider, the notification relating to at least one of a failure status of the item of equipment and a quality indicator relating to the service provided via the item of equipment;
(b) assigning the notification to an original equipment manufacturer, the original equipment manufacturer selected in dependence upon at least the item of equipment;
(c) assigning a corrective action to a professional service organization, at least one of generating the corrective action and selecting the professional service organization is made in dependence upon at least one of the notification, an aspect of the item of equipment, the service provider and original equipment manufacturer;
(d) performing a repair operation to the item of equipment, the repair operation performed by at least one of an individual and a computer associated with the professional service organization.

2. A method according to claim 1 wherein;
step (a) further comprises performing a first corrective action by the service provider to at least one of correct the failure status and improve the quality indicator and not achieving the intended result.

3. A method according to claim 1 wherein;
step (c) further comprises performing a second corrective action by the original equipment manufacturer to at least one of correct the failure status and improve the quality indicator and not achieving the intended result.

4. A method according to claim 1 wherein;
step (d) comprises performing the repair operation remote from the physical location of the item of equipment.

5. A method according to claim 4 wherein;
the repair operation is performed by the technician in conjunction with a second remote repair operation performed by at least one of the professional service organization and the original equipment manufacturer.

6. A method according to claim 1 wherein;
step (d) comprises performing the repair operation at the physical location of the item of the item of equipment wherein the individual performing the repair operation does not require additional spares beyond those within their normal inventory of spares.

7. A method according to claim 1 wherein;
step (d) comprises performing the repair operation at the physical location of the item of the item of equipment wherein the individual performing the repair operation requires at least an additional spare beyond those within their normal inventory of spares.

8. A method according to claim 7 wherein;
step (d) is performed after the at least an additional spare has been dispatched by at least one of the professional service organization and the original equipment manufacturer to at least one of the technician, the location of the item of equipment, and a predetermined location established in dependence upon at least one of the technician, a warehouse of the professional service organization, a warehouse of the original equipment manufacturer, the location of the item of equipment, the intended day of the repair operation and the time of the intended repair operation.

9. A method according to claim 1 wherein;
step (d) comprises the technician performing the repair operation at the physical location of the item of the item of equipment in conjunction with a remote operation performed by at least one of the professional service organization and the original equipment manufacturer.

10. A method according to claim 1 wherein;
Step (c) further comprises receiving an acknowledgement from the professional service organization within a predetermined period of time, the predetermined period of time determined in dependence upon at least a service level agreement between the professional service organization and the original equipment manufacturer.

11. A method according to claim 1 further comprising:
(e) compensating at least one of the professional service organization and the original equipment manufacturer in dependence upon a factor.

12. A method according to claim 11 wherein;
the factor is at least one of the quality indicator level after the repair operation has been performed, the duration of time between the notification and a successful repair operation, the service provided by the item of equipment.

12. A method according to claim 1 further comprising:
(f) performing the repair operation on a predetermined number of items of same item of equipment as a preventative maintenance activity.

13. A method according to claim 1 further comprising:
(g) engaging a supplier to the original equipment manufacturer, the engagement being undertaken wherein the repair operation of step (d) is unsuccessful and the support of the supplier to perform a second repair operation is required to at least one of remove the fault and improve the level of the quality indicator.

14. A method according to claim 1 wherein;
step (a) comprises receiving at least one of a customer contacting the service provider, a customer contacting a call center associated with the service provider, receiving at the service provider an electronic message from a customer, and receiving an electronic message from the item of equipment.

15. A method according to claim 1 wherein;
At least one of the notification and corrective action comprise a measure of importance relating to the severity of the at least one of failure status and quality service degradation.

16. A method according to claim 1 further comprising;
(h) automatically performing the repair operation with the computer associated with the professional service organization where the received corrective action relates to a known issue of the item of equipment and is resolvable by the transfer of data to the item of equipment.

17. A method comprising:
(a) receiving a notification relating to an item of equipment supporting a service from a service provider, the notification relating to at least one of a failure status of the item of equipment and a quality indicator relating to the service provided via the item of equipment;
(b) providing a second notification relating to the item of equipment, the second notification sent from an original equipment manufacturer to the service provider, the original equipment manufacturer determined in dependence upon at least one of the item of equipment, the service provider employing the item of equipment, the service provided via the item of equipment, and a priority relating to the notification;
(c) assigning a corrective action to a professional service organization, at least one of generating the corrective action and selecting the professional service organization is made in dependence upon at least one of the notification, an aspect of the item of equipment, the service provider and original equipment manufacturer;
(d) performing a repair operation to the item of equipment, the repair operation performed by at least one of an individual and a computer associated with the professional service organization.

18. A method comprising:
(a) receiving a notification relating to an item of equipment belonging a service from a service provider, the notification relating to at least one of a failure status of the item of equipment and a quality indicator relating to the service provided via the item of equipment;
(b) providing a second notification relating to the item of equipment, the second notification sent from a professional service organization to at least one of an original equipment manufacturer and the service provider, the original equipment manufacturer determined in dependence upon at least one of the item of equipment, the service provider employing the item of equipment, the service provided via the item of equipment, and a priority relating to the notification;
(c) assigning a corrective action to a predetermined part of the professional service organization, at least one of generating the corrective action and selecting the predetermined part of the professional service organization being made in dependence upon at least one of the notification, an aspect of the item of equipment, the service provider and original equipment manufacturer;
(d) performing a repair operation to the item of equipment, the repair operation performed by at least one of an individual and a computer associated with the predetermined part of the professional service organization.
